(19) United States
(12) Patent Application Publication
(10) Pub. No.: US 2025/0280771 A1
(43) Pub. Date: Sep. 11, 2025

(54) D-Vine Flex Support System and Related Methods

(71) Applicant: Reuben Onwugbonu, Hillside, NJ (US)

(72) Inventor: Reuben Onwugbonu, Hillside, NJ (US)

(21) Appl. No.: 19/067,793

(22) Filed: Feb. 28, 2025

Related U.S. Application Data
(60) Provisional application No. 63/563,414, filed on Mar. 10, 2024.

(51) Int. Cl. A01G 17/06

(52) U.S. Cl. CPC A01G 17/06

(57) ABSTRACT

The present invention relates to a modular and adaptable plant support system, D-Vine Flex, designed to support various plant types, including climbing and fruit-bearing plants, in indoor and outdoor environments. The system features interlocking components for customizable configurations such as linear, grid, and pyramid-shaped structures. An adjustable support post assembly with telescoping and pivoting mechanisms accommodates plant growth. Reinforced load-bearing sections provide stability for heavier plants. Integrated irrigation and nutrient delivery systems, including drip irrigation, misting sprayers, and automated soil moisture and pH sensors, optimize plant health. Advanced anchoring mechanisms, such as deep-ground spike anchors and weighted base supports, ensure structural stability. Collapsible and portable features, including foldable frames and quick-release fasteners, allow for easy storage and transport. By combining adaptability, automated care, and enhanced stability, the D-Vine Flex system offers a versatile and efficient plant cultivation solution, promoting improved plant health and productivity.

This application claims the benefit to U.S. Provisional Application No. 63/563,414, filed on Mar. 10, 2024, and U.S. Provisional Application No. 63/659,095, filed on Jun. 12, 2024, which applications are herein incorporated by reference as if set forth in its entireties.

### FIELD OF THE INVENTION

The invention pertains to a net-based plant support system, D-Vine Flex, designed for both indoor and outdoor plants. It provides a structure for vines and young plants to be anchored and managed, promoting healthier growth. The present invention relates generally to plant support systems and methods, and more particularly to an apparatus and method configured to provide structural support to plants and vines, facilitating its growth in various environments.

### BACKGROUND

Traditional plant support systems often lack adaptability, failing to accommodate diverse gardening methods, environmental conditions, and plant growth patterns. Conventional staking and trellising solutions may restrict airflow, sunlight exposure, and water drainage, thereby limiting the natural development of plants. Therefore, there exists a need for an improved plant support system that enhances plant management while promoting flexibility in structure arrangement. The cultivation and management of plants, particularly those with vines, is a task that requires careful attention and specific tools. Traditional methods of supporting and staking plants often involve rigid structures that may not provide the necessary flexibility for optimal plant growth. These methods may also limit the plant's exposure to essential elements such as sunlight and air and may hinder the plant's ability to drain water effectively. Furthermore, these traditional methods may not provide adequate access for necessary plant care activities such as weeding, pruning, watering, fertilizing, and pest control. The cultivation of plants in containers, particularly those with vines, presents additional challenges. Additionally, the process of pollination, whether natural or manual, can be hindered by the physical barriers presented by traditional plant support systems. The need for a more flexible, adaptable, and efficient method of supporting and managing plants, particularly those with vines, is evident.

### SUMMARY

In accordance with the embodiments herein described, a plant support system is provided. The system provides support to various types of plants, facilitates natural growth, enables effective management, enhances environmental conditions for plant growth, facilitates plant care activities, supports diverse gardening methods, promotes plant reproduction, offers various plant support methods, exhibits user-friendly and long-lasting characteristics, demonstrates load-bearing capacity, allows various structure configurations, and provides aesthetic benefits.

In accordance with other embodiments, a method for supporting plants is provided. The method involves providing a plant support system and using it to provide support to various types of plants, facilitate natural growth, enable effective management, enhance environmental conditions for plant growth, facilitate plant care activities, support diverse gardening methods, promote plant reproduction, offer various plant support methods, exhibit user-friendly and long-lasting characteristics, demonstrate load-bearing capacity, allow various structure configurations, and provide aesthetic benefits.

In a preferred embodiment, the plant support system comprises a modular and adaptable framework that can be configured based on specific plant growth needs. The system includes multiple interlocking components that provide structural integrity and allow customization based on plant size and growth patterns. These interlocking elements enable the formation of linear, grid, or pyramid-shaped support structures to optimize space utilization and plant distribution.

The system integrates an adjustable support post assembly that allows users to modify the height and orientation of the structure. This feature is particularly beneficial for supporting climbing plants such as tomatoes, beans, and ivy, which require vertical extension as they grow. The adjustable support posts include telescoping sections for incremental height adjustments, as well as pivoting mechanisms to enable directional guidance.

Reinforced load-bearing sections are incorporated to enhance stability, making the system suitable for heavier plant varieties, such as fruit-bearing plants and dense foliage. The reinforcement includes cross-braced support frames that evenly distribute weight, dual-column reinforced posts that prevent structural bending, and load-adjustable support beams that can be configured based on plant weight distribution.

The preferred embodiment also integrates an automated watering and nutrient delivery system. This system includes drip irrigation channels for targeted root hydration, misting sprayers for high-humidity plants, and a fertilizer injection system that mixes and distributes nutrients through irrigation lines. Additionally, soil moisture and pH sensors are embedded in the framework to monitor plant health and automatically adjust watering and nutrient levels. For enhanced stability in outdoor environments, the system features a set of advanced anchoring mechanisms. These include deep-ground spike anchors for securing the structure in soil, weighted base supports to prevent tipping, auger-type screw anchors for firm ground attachment, and an interlocking ground grid that distributes weight evenly.

The preferred embodiment is also designed for collapsibility and portability, making it ideal for seasonal gardening setups. It incorporates foldable frames with hinged joints for compact storage, telescoping support poles for easy height adjustments, and quick-release fasteners for tool-free assembly. A lightweight anchoring system with removable ground stakes further enhances portability, while self-expanding frames allow for rapid deployment in temporary installations.

By combining modular adaptability, automated irrigation, enhanced anchoring, and collapsible portability, the preferred embodiment of the plant support system ensures versatility across various gardening methods and environments. This comprehensive design provides an efficient and durable solution for plant cultivation, enhancing overall plant health and productivity. More importantly, the structure of netting allows for a much secure, faster and easier way of anchoring plants/vines as opposed to the existing methods.

### BRIEF DESCRIPTION OF THE DRAWINGS

The teachings of the present invention can be readily understood by considering the following detailed description in conjunction with the accompanying drawings, in which:

FIG. 1 illustrates, in a flowchart, operations for providing a versatile plant support system in accordance with certain embodiments;

FIG. 1A illustrates, in a flowchart, operations for providing a plant support system in accordance with certain embodiments;

FIG. 1B illustrates, in a flowchart, operations for using the plant support system to provide a more natural feel and desired control to plants in accordance with certain embodiments;

FIG. 1C illustrates, in a flowchart, operations for facilitating the natural growth of plants by improving air flow, sun exposure, and water drainage in accordance with certain embodiments;

FIG. 1D illustrates, in a flowchart, operations for enabling effective management of plants by providing better access for working around the plants in accordance with certain embodiments;

FIG. 1E illustrates, in a flowchart, operations for enhancing environmental conditions for plant growth by allowing cultivation of plants with vines in containers and indoors in accordance with certain embodiments;

FIG. 2 illustrates, in a block diagram, the components of a Plant Support Framework in accordance with certain embodiments;

FIG. 3 illustrates an exemplary embodiment of the plant support system;

FIG. 4 shows a different configuration of the plant support system;

FIG. 5 presents another embodiment;

FIG. 6 details an alternative structure arrangement;

FIG. 7 illustrates another variation of the plant support system;

FIG. 8 depicts a further embodiment, highlighting elements 800, 805, 810, 815, 820, 825, and 830.

FIG. 9 illustrates a final variation including components 900, 905, 910, 915, 920, 925, 930, and 935.

### DETAILED DESCRIPTION OF THE INVENTION

The plant support system of the present invention comprises an apparatus designed to accommodate various structural arrangements demonstrating load-bearing capacity. The system integrates flexible netting, which assists in staking plants and vines, thereby allowing for improved airflow, sun exposure, and water drainage. This enhances the overall plant growth environment while permitting greater control of plants and vines across a wide range of conditions.

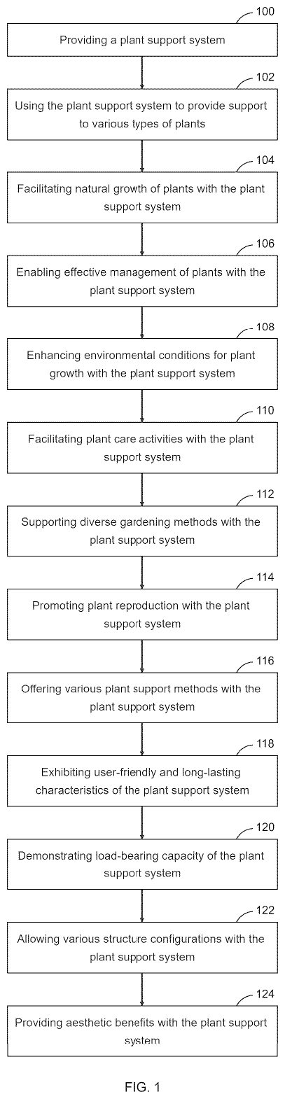

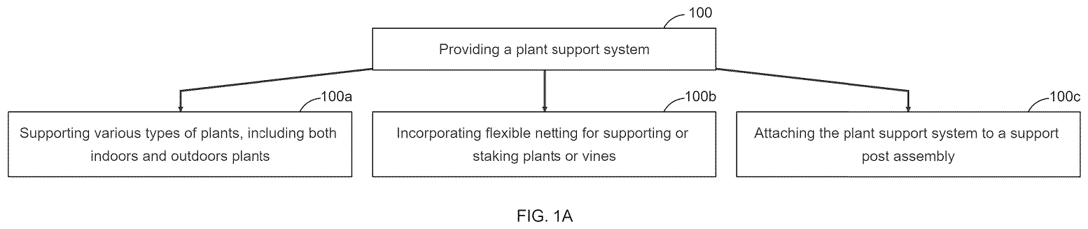

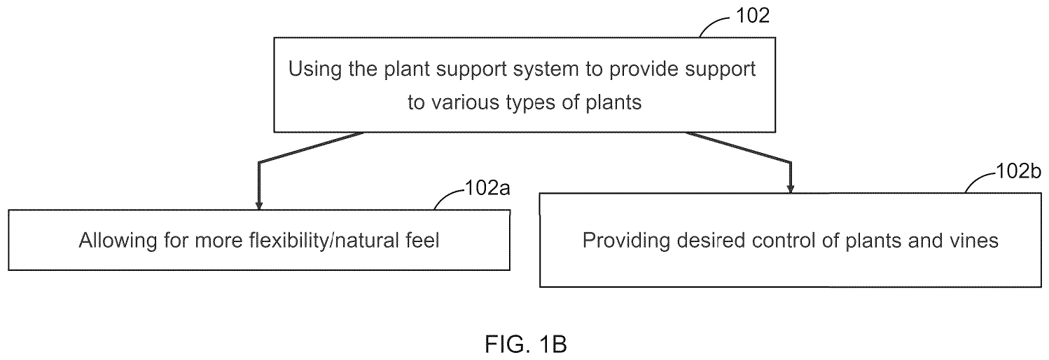

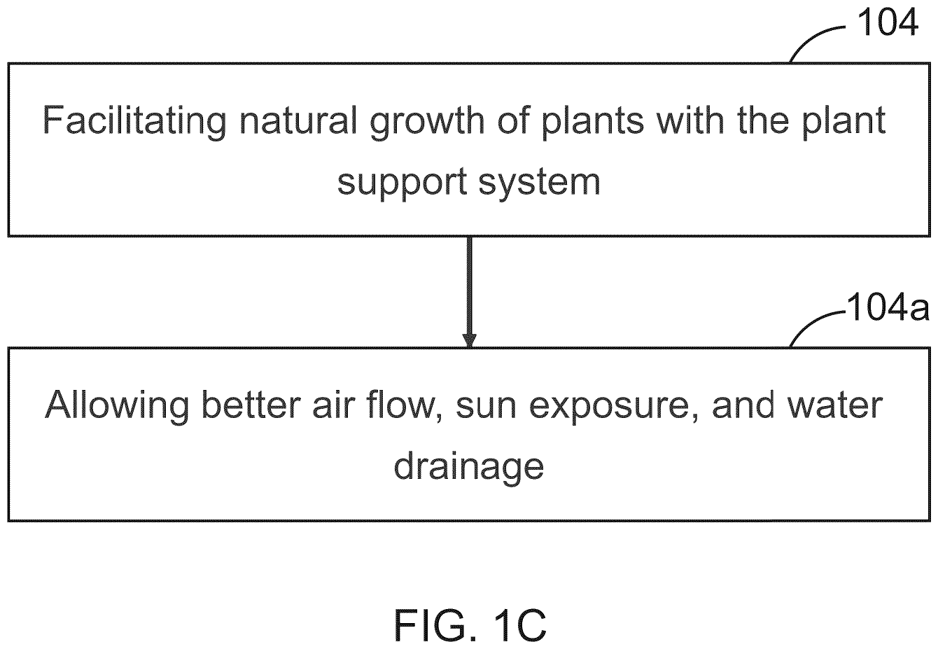

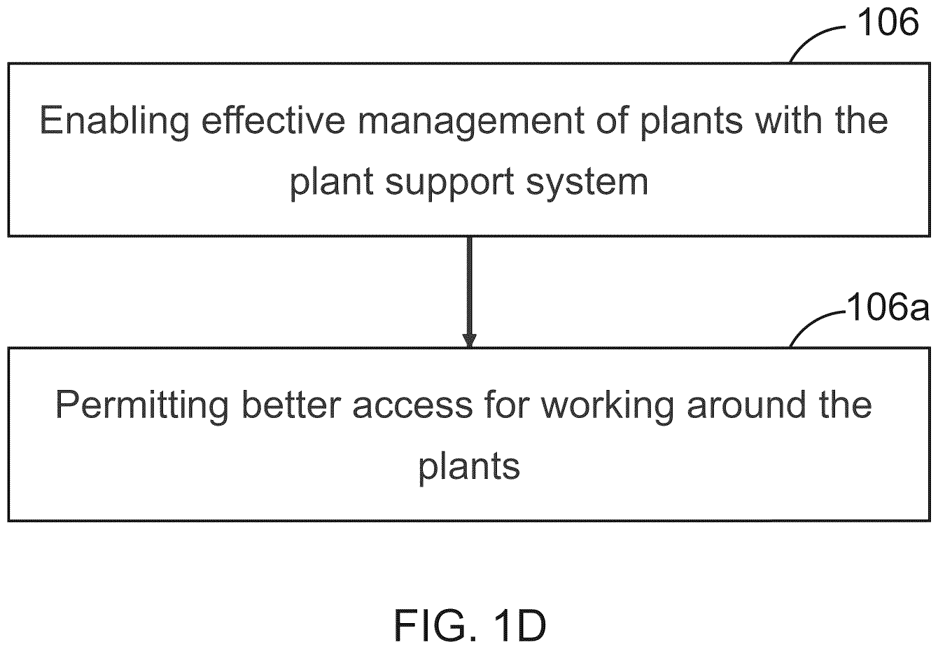

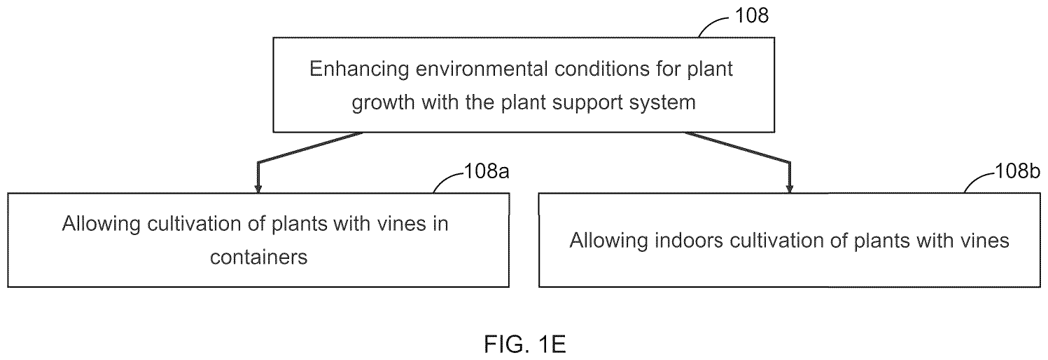

FIG. 1 illustrates the overall structure of the plant support system, showing its adaptability to different gardening environments. The figure demonstrates how the system can be configured to support plants in diverse conditions, including container-based gardening, vertical gardens, and traditional soil-based setups.

FIG. 1 illustrates, in a flowchart, operations for providing a versatile plant support system in accordance with certain embodiments;

FIG. 1A illustrates, in a flowchart, operations for providing a plant support system in accordance with certain embodiments;

FIG. 1B illustrates, in a flowchart, operations for using the plant support system to provide a more natural feel and desired control to plants in accordance with certain embodiments;

FIG. 1C illustrates, in a flowchart, operations for facilitating the natural growth of plants by improving air flow, sun exposure, and water drainage in accordance with certain embodiments;

FIG. 1D illustrates, in a flowchart, operations for enabling effective management of plants by providing better access for working around the plants in accordance with certain embodiments;

FIG. 1E illustrates, in a flowchart, operations for enhancing environmental conditions for plant growth by allowing cultivation of plants with vines in containers and indoors in accordance with certain embodiments;

Step 100 involves the action of making the D-Vine Flex plant support system available to users. This step is the foundational action of offering a system designed to support plants.

The actions involved in Step 100 are as follows:
1. **Providing**: This action refers to making the D-Vine Flex plant support system accessible to those who wish to support their plants. It involves the manufacturer or supplier ensuring that the system can be obtained by gardeners, farmers, or indoor plant enthusiasts.
2. **Plant Support System**: This is the product, the D-Vine Flex, which includes all components and features necessary to support plants. It is a tangible system that users can install and utilize for their plants.

In practice, the action of making a plant support system available (Step 100) involves the production, marketing, and distribution of the D-Vine Flex system to potential users. The system itself is designed to support various types of plants, as indicated in sub-step 100-a (FIG. 1A), and includes flexible netting (sub-step 100-b—FIG. 1A) that is connected to a support post assembly (sub-step 100-c—FIG. 1C). The flexible netting allows for the growth and management of plants, offering benefits such as improved air flow, sun exposure, and water drainage, as well as facilitating care activities like weeding, pruning, and harvesting.

The participants in this step include the manufacturer of the D-Vine Flex system, the distribution channels that make the system available to consumers, and the end-users who will be installing and using the system to support their plants. The action of making available is carried out by the manufacturer and distributors, while the action of using the plant support system is carried out by the end-users. The goal of this step is to ensure that the D-Vine Flex system is accessible to those who need it and that it fulfills its intended purpose of supporting plant growth effectively.

Step 102 involves the application of the D-Vine Flex system to support plant growth. This step includes the interaction between the plant and the support system, where the plant is secured to a flexible netting that is part of the overall support structure. The netting is connected to a support post assembly, which provides the necessary stability for the system.

Sub-step 102-a (FIG. 1B) focuses on the flexibility of the netting, which allows plants to grow with a degree of movement. This flexibility is designed to accommodate the natural tendencies of plant growth, allowing for a more natural development pattern without the constraints that might be imposed by a more rigid structure.

Sub-step 102-b (FIG. 1B) involves the guidance of plant growth. The system is used to manage the direction and spacing of plant growth. Gardeners can adjust the positioning of plants by fastening them to the netting, which can be done using clips or flexible wire stripes. This management allows for the organization of plant growth in a way that optimizes space and maintains the aesthetic layout of the garden.

In step 102, the system provides a surface for plants to attach to or be tied to, and the flexibility of the netting accommodates growth while reducing stress on the plant structure. The guidance aspect is achieved by the gardener, who can manipulate the positioning of the plants on the netting to achieve a specific growth pattern or direction.

Step 104 involves the use of a plant support system to support the growth of plants in a manner that allows them to develop without unnatural constraints. The system is designed to provide support without dictating the shape or direction of growth, allowing plants to follow their natural growth patterns. The support system includes netting that holds the plants while permitting movement and growth in various directions.

Sub-step 104-a (FIG. 1C) focuses on optimizing environmental factors that are necessary for healthy plant development. The netting in the support system is structured to permit air to circulate freely around the plants, which helps to prevent the accumulation of moisture that can lead to fungal diseases. It also ensures that plants receive sufficient sunlight from multiple angles, which is necessary for the process of photosynthesis. Additionally, the netting allows excess water to drain away from the plants, reducing the likelihood of waterlogging and root diseases.

The components involved in step 104 and sub-step 104-a (FIG. 1C) include the support system with its netting and support posts, the plants, and environmental elements such as air, light, and water. The support system interacts with these elements to create an environment conducive to plant growth. The netting is attached to the support posts, and plants are guided to grow through the netting, which supports them while allowing interaction with the surrounding environment.

In practice, the installation of the support system involves setting up the support posts and attaching the netting. Plants are then positioned in relation to the netting to allow them to grow through it. As the plants mature, they benefit from the air circulation, light exposure, and water drainage facilitated by the netting structure, which supports their natural growth.

Step 106 focuses on the management of plants using the D-Vine Flex system. This step involves the use of flexible netting to provide a structure that supports the growth of plants and vines. The netting allows plants to grow in a manner that prevents breakage and promotes health. The gardener or user interacts with the system to arrange the plants for optimal growth conditions, ensuring that the plants receive adequate air flow, sun exposure, and water drainage.

The D-Vine Flex system, as part of Step 106 (FIG. 1D), is designed to accommodate the natural growth patterns of plants while providing support. The gardener uses the system to manage the plants, which includes activities such as weeding, pruning, harvesting, watering, fertilizing, and pest control measures. The system is structured to allow the gardener to perform these tasks with ease.

Sub-step 106-a (FIG. 1D) addresses the accessibility for garden maintenance. This sub-step highlights the design of the system that allows the gardener to work around the plants without obstruction. The system's layout is such that it facilitates access to the plants for regular care and maintenance.

In essence, Step 106 and Sub-step 106-a outline the procedures for managing plants using the D-Vine Flex system. The system's flexible netting supports the plants, and the design of the system allows for ease of access for garden maintenance tasks.

Step 108 (FIG. 1E) focuses on the enhancement of conditions that facilitate plant growth within the support system. This step involves the configuration of the support system to allow for sufficient space between the plants and the netting, promoting air circulation. Proper air circulation is necessary to reduce the risk of plant diseases and to supply plants with carbon dioxide for photosynthesis.

Additionally, the support system is structured to avoid obstructing sunlight from reaching the plants. Sunlight is a key component for photosynthesis, enabling plants to produce energy for growth. The design of the support system also ensures that water does not accumulate around the plant base, which can lead to detrimental conditions such as root rot. The netting is such that it permits water to drain away from the plant area efficiently.

Sub-step 108-a (FIG. 1E) addresses the capability of the support system to be utilized for plants grown in containers. This sub-step reflects the adaptability of the support system to different growing environments, including those outside of traditional garden settings. Sub-step 108-b (FIG. 1E) extends this adaptability to indoor settings, where the support system can be used to cultivate plants with vines under controlled conditions, such as regulated temperature, humidity, and light exposure.

The physical structure of the support system in Step 108 (FIG. 1E), including the netting and support post assembly, is designed to maintain these conditions without compromising the system's ability to support plant growth. The system is adaptable to accommodate various plant sizes and growth patterns, ensuring that the conditions for plant growth are optimized.

Step 110 (FIG. 1) addresses the facilitation of plant care activities with the support system. This step involves a series of actions that are necessary for the upkeep of plants. These actions include weeding, which is the removal of unwanted plants; pruning, which is the selective cutting of plant parts; harvesting, which is the collection of produce; watering, which is the application of water; fertilizing, which is the addition of nutrients; and applying measures to control pests that can harm the plants.

The support system, with its flexible netting and support post assembly, provides a structure that aids in the execution of these activities. The design of the system allows for ease of access to the plants, which simplifies the process of performing the aforementioned activities. The netting supports the plants and maintains adequate spacing, which helps to prevent the plants from becoming too dense. This spacing not only eases the process of plant care but also contributes to better air circulation, exposure to sunlight, and efficient water drainage.

In essence, FIG. 1, step 110 involves the application of the support system to enhance the efficiency of routine plant maintenance. The system's design, which includes the ability to support the plants while allowing for space between them, enhances the ability to maintain and care for the plants, leading to healthier growth and potentially better yields.

FIG. 1, step 112 focuses on the capability of the D-Vine Flex system to support a range of gardening practices. This step involves the D-Vine Flex system's netting and support post assembly, the user, and the plants. The netting can be configured to support plants in various gardening methods, such as in-ground, raised bed, container, vertical, and hydroponic systems.

The D-Vine Flex system's netting is designed to be adjustable to support plants according to the specific requirements of the gardening method utilized. For example, in vertical gardening, the netting can be arranged to allow plants to grow upward along walls or frames, optimizing space usage. In the context of container gardening, the netting can be tailored to the dimensions of the container to provide the necessary support for plant growth. The support post assembly can be installed in different layouts to match the specifications of the gardening method.

The user assesses the growth needs of their plants and the spatial constraints, then adjusts the D-Vine Flex system to meet these needs. This may involve modifying the netting's dimensions, altering the arrangement of the support posts, or using multiple systems for expansive garden projects. The system is designed to be adaptable for both indoor and outdoor gardening, offering a supportive environment that accommodates specific plant growth patterns and garden conditions.

FIG. 1, step 114 involves the promotion of plant reproduction through the use of a support system. This step encompasses the provision of a structure that supports the growth and spread of plants and vines. The structure includes flexible netting and a support post assembly. The netting serves as a scaffold for plants to climb and expand, which is necessary for healthy growth and the development of reproductive parts such as flowers.

The actions involved in Step 114 include the physical support of plants, ensuring they have the space to grow without being restricted, which leads to better flower development. Flowers are the reproductive organs for many plant species, and their development is essential for the production of fruits and seeds. The design of the support system also allows for increased airflow and exposure to sunlight, which are favorable conditions for pollination and the development of fruits and seeds.

Additionally, the system's configuration allows for ease of access to the plants, which facilitates the process of pollination by insects and, if needed, by manual methods. By providing these conditions, the support system aids in the natural and healthy reproduction of plants. Step 114 is integral to the system's overall function of supporting plant growth in a manner that enhances their reproductive capabilities.

FIG. 1, step 116 involves the provision of multiple methods for supporting plants using the D-Vine Flex system. This step includes the design and use of the system to accommodate different plant support needs through various configurations of the flexible netting, such as parallel, horizontal, or diagonal layouts. The components of the D-Vine Flex system (flexible netting, support post assembly, clips, or wire stripes) and the user who implements the system are the focus of this step.

The user, typically a gardener or horticulturist, selects the method based on the type of plant, its growth pattern, and the specific requirements for growth. For instance, a vine that grows horizontally might be supported by a parallel netting layout, while a climbing plant might require a vertical or diagonal configuration. The user installs the D-Vine Flex system by attaching the netting to the support post assembly and securing the plants to the netting using clips or wire stripes.

The purpose of these actions is to ensure that the plants are supported in a way that allows for growth patterns, air flow, sun exposure, and water drainage, as well as ease of access for care activities such as weeding, pruning, and harvesting. By providing multiple methods for plant support, the D-Vine Flex system offers a solution that can be adapted to the needs of different plants and gardening situations, whether in containers or in the ground, indoors or outdoors. In summary, step 116 involves providing and implementing multiple methods for plant support using the D-Vine Flex system to cater to the varied needs of plant growth and management, ensuring the system's adaptability and effectiveness in various gardening contexts.

FIG. 1, step 118 focuses on the characteristics of the D-Vine Flex plant support system that facilitate ease of use and longevity. The system is designed to be straightforward for users to set up and interact with. This includes the assembly process, the method of attaching the netting to the support posts, and the adjustability to suit various plant sizes and growth patterns. The intention is for users to manage the system without requiring extensive gardening knowledge or experience.

Additionally, step 118 encompasses the durability aspects of the system. The materials selected for the netting and support posts are chosen for their ability to endure environmental stressors such as weather conditions and the load from plants over time. The netting is structured to remain intact without sagging or tearing, and the support posts are treated to resist corrosion and wear.

The focus of step 118 is on the design and material selection that contribute to a system that can be used with ease and can sustain its structural integrity over multiple growth cycles, thereby providing a reliable solution for plant support. This step is essential for user satisfaction and the practical application of the system in various gardening scenarios.

FIG. 1, step 120 focuses on the load-bearing capacity of the plant support system. This step involves assessing the ability of the system to sustain the weight of plants as they grow and develop, particularly when they start to bear fruit or flowers, which increases the weight they carry. The load-bearing capacity is determined by the physical properties of the materials used in the system, such as the netting and support post assembly.

The netting must be constructed from a material that can hold the weight of the plants without tearing, while the support posts must be robust enough to withstand the load without bending or snapping. The design of the system, including the method by which the netting is attached to the posts and the way the posts are secured in the ground or containers, contributes to the overall strength and stability of the system.

The purpose of step 120 (FIG. 1) is to ensure that the support system can sustain the weight of a variety of plant types throughout their growth, including when they are heavy with fruit or flowers. This is necessary for the well-being of the plants and for the ease of maintenance by the gardener, as a support system that cannot hold the weight can lead to disarray and potential hazards. In essence, step 120 involves the material selection, structural design, and installation technique of the plant support system, which collectively ensure that the system can support the weight of growing plants and vines effectively.

FIG. 1, step 122 involves the capability of the D-Vine Flex system to be arranged in multiple structural layouts. This step focuses on the user's interaction with the system components to create a support structure that can be tailored to the needs of the plants and the space available. The user engages with the flexible netting and support post assembly, configuring these components into various shapes and sizes. This may include adjusting the dimensions of the support posts, bending or cutting the netting to fit specific patterns, and connecting multiple units to extend the support area. The purpose of step 122 is to provide a support system that can be customized for different plant types and growth patterns without requiring specialized tools or complex assembly processes. The flexibility of the system allows the user to modify the layout as plants grow or as the user's preferences change. This step ensures that the system can be used in a range of environments, from small indoor spaces to larger outdoor gardens, and for plants with different staking requirements. In practice, step 122 is manifested through the user's selection and arrangement of the system's components. The user determines the configuration that best suits their needs and assembles the system accordingly. This step is integral to the functionality of the D-Vine Flex system, as it provides the adaptability necessary to support a variety of plant types and gardening methods.

FIG. 1, step 124 focuses on the aspect of the D-Vine Flex system that contributes to the visual appeal of the space where it is installed. The system is designed with a flexible netting that allows for a variety of configurations, such as parallel, horizontal, or diagonal layouts. This flexibility enables the system to support plants in a way that minimizes visual interference, allowing the plants to be the primary focus.

The system's design, which includes the use of flexible netting, is key to achieving this visual integration. The netting can be adjusted to accommodate the growth patterns of the plants, which helps to maintain a natural appearance. The support provided by the system is sufficient to bear the weight of the plants, including those that bear fruit, without becoming a dominant visual element in the environment.

The purpose of step 124 is to enhance the enjoyment of the space for observers and users by creating a harmonious environment. A visually appealing plant support system can contribute to a more satisfying experience for those who interact with the space, whether it is for gardening, viewing, or other activities. The system's design aims to complement the plants it supports, creating an environment that is both functional and aesthetically pleasing.

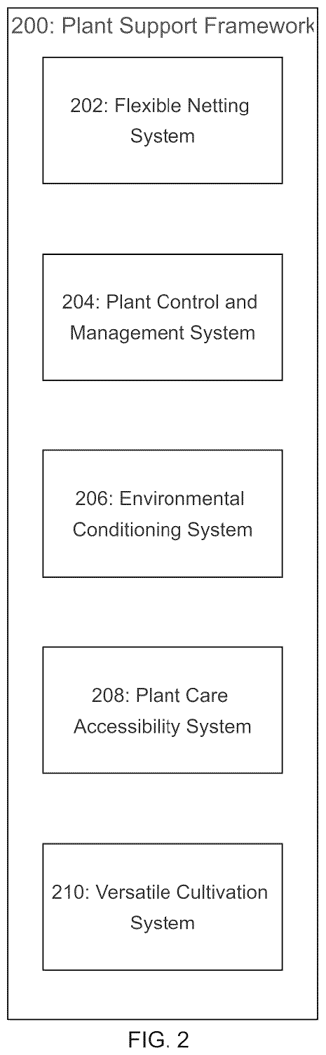

FIG. 2 details the netting integration 200 within the support structure, emphasizing how the flexible netting system attaches to the frame. This configuration enables the system to accommodate various plant growth patterns while providing necessary support and stability. The plant support system is adaptable to both indoor and outdoor gardening applications. The support structure may be attached to a support post assembly to facilitate plant care activities.

By incorporating flexible configurations, the system permits improved access for maintenance and care, making it a suitable option for diverse gardening methods, including vertical gardening, hydroponic setups, and container gardening.

The Plant Support Framework (200) is designed to enhance the growth and management of plants, providing a solution for gardeners. This system includes the Flexible Netting System (202), which uses netting to support plants. The Plant Control and Management System (204) ensures flexibility and control over plant growth. The Environmental Conditioning System (206) optimizes conditions for air, sunlight, and water. The Plant Care Accessibility System (208) improves access for maintenance activities, and the Versatile Cultivation System (210) supports diverse gardening practices, including container and indoor cultivation.

The Plant Support Framework (200) provides stability and support to a variety of plants in different environments. It accommodates natural growth patterns, anchoring plants in a way that promotes healthier development. The Flexible Netting System (202) is integral for supporting and staking plants, with the netting's adaptability being key to managing plant growth. It can be configured in various layouts to meet the needs of different plant species.

The Plant Control and Management System (204) allows plants to grow with a natural feel, providing necessary control over their development. It facilitates better air circulation, sunlight exposure, and water drainage. The Environmental Conditioning System (206) ensures that these environmental factors are optimized for plant health. The Plant Care Accessibility System (208) allows for easy maintenance tasks, such as weeding and pruning. The Versatile Cultivation System (210) enables cultivation in containers and indoor settings, supporting a range of gardening methods and plant types. This system also contributes to the aesthetic setup, creating an appearance of plants growing effortlessly.

The Flexible Netting System (202) is a part of the D-Vine Flex plant support system, which provides a means of supporting and staking plants or vines. This system uses a mesh that attaches to a support post assembly, allowing for secure support of plants while maintaining their natural growth patterns.

The Flexible Netting System (202) includes a mesh made from a material that balances strength and flexibility. This material supports the weight of plants and fruit while allowing for natural growth. The netting is designed to prevent damage to the plants and ensure unrestricted growth, which is essential for vining plants that require support to grow upwards.

The netting is engineered to attach to a support post assembly, which acts as the main structure for plant support. The attachment method allows for different configurations, such as parallel, horizontal, and diagonal layouts, to accommodate various plant types and garden designs. This versatility supports the physical needs of the plants and contributes to the garden's layout. The design of the netting ensures that it does not obstruct air flow or sunlight and allows water to drain easily, which is beneficial for plant health. The open structure of the netting also provides gardeners with access to the plants for maintenance activities such as pruning, harvesting, and pest control. The system is practical for both indoor and outdoor gardening applications.

The Plant Control and Management System (204) is a part of the D-Vine Flex, designed to support plant growth by providing flexibility and control. This system allows for a more natural growth environment for plants, ensuring they are well-managed and supported. Within the D-Vine Flex framework, the Plant Control and Management System (204) is engineered to enhance the growth and management of plants, particularly those with vines. This system provides a flexible structure that allows vines and young plants to anchor securely while avoiding the constraints of traditional rigid staking methods. It offers gardeners the ability to control the direction and form of plant growth, which is beneficial for fruit-bearing plants or those that require specific shapes for optimal growth and yield.

The system is designed to improve air circulation and sunlight exposure, which are vital for photosynthesis and preventing the onset of fungal diseases. It also facilitates better water drainage, ensuring that the roots of the plants do not sit in excess water, which could lead to root rot. The design takes into account the ease of access for gardeners to perform routine care activities such as pruning, harvesting, and pest control. By providing adequate spacing and support, it ensures that plants can be easily accessed from all angles, simplifying maintenance tasks.

Furthermore, the system supports the reproductive process of plants by allowing for better access to flowers for pollinating insects, which is necessary for fruit set in many crops. The Plant Control and Management System (204) addresses the physical, environmental, and maintenance needs of plants, contributing to their health and productivity.

The Environmental Conditioning System (206) is part of the D-Vine Flex plant support system, designed to enhance plant growth by optimizing air flow, sunlight exposure, and water drainage. The system (206) includes features that ensure plants receive adequate air circulation, sufficient sunlight, and proper water drainage, which are essential for healthy plant development. The system is pivotal in ensuring that plants receive the necessary environmental stimuli to thrive. It operates by enhancing air circulation around the foliage, which reduces the incidence of fungal diseases and promotes plant health. The strategic positioning and design of the system facilitate unobstructed airflow, beneficial when plants are densely packed or when humidity levels are high.

Simultaneously, the system is configured to maximize sunlight interception by the plants. Sun exposure is essential for photosynthesis, the process by which plants convert light energy into chemical energy. By ensuring that plants are not overshadowed by the support structure itself, the system promotes efficient energy conversion and healthier plant growth.

Furthermore, the Environmental Conditioning System (206) is designed to improve water management around the plants. It allows for quick drainage and drying, preventing waterlogging and root rot. The system's configuration prevents water accumulation by facilitating its movement away from the plant base, thereby maintaining an optimal moisture level in the soil.

The integration of these features into the Environmental Conditioning System (206) is methodically planned through the use of materials and structural designs that do not impede natural environmental processes, supporting the plant's growth in a manner that mimics its natural habitat. This approach to environmental conditioning underscores the system's role in fostering a conducive growth environment for both indoor and outdoor plants.

The Plant Care Accessibility System (208) is part of the D-Vine Flex, designed to enhance the ease of maintaining plants by improving access for various gardening activities. This system (208) allows for unobstructed access to the plants, which is essential for routine care activities such as weeding, pruning, harvesting, watering, fertilizing, and applying pest control measures. The system (208) provides gardeners with the ability to navigate around the plants without obstruction, which is necessary when performing tasks that require close contact with the plants. For instance, weeding requires the removal of unwanted flora from the vicinity of the plants, and the accessibility provided by this system ensures that such tasks can be performed efficiently. Pruning involves the selective trimming of plant parts to improve health and growth, and the system allows for easy reach to all parts of the plant, enabling precise cuts.

Harvesting is also facilitated by the system (208), as it allows gardeners to collect fruits and vegetables with minimal disturbance to the plant structure. The layout of the system ensures that watering and fertilizing activities can be conducted effectively, with ample space to distribute resources evenly around the plant base. Pest control measures benefit from the system as well, as it allows for thorough inspection and treatment application to all areas of the plant.

The methodical layout of the Plant Care Accessibility System (208) within the D-Vine Flex ensures that maintenance activities can be conducted effectively, contributing to the health and productivity of the plants. This system is integrated within the plant support framework to provide functionality and ease of use for gardeners.

The Versatile Cultivation System (210) is designed to support the growth of plants with vines in containers and indoor environments. This system is a part of the D-Vine Flex, enhancing the adaptability and utility of the plant support framework. It includes two main functionalities: enabling the cultivation of plants with vines in containers (9) and supporting the indoor cultivation of plants with vines (10). This capability ensures that the D-Vine Flex can be used in diverse gardening scenarios, providing flexibility and control over plant growth and maintenance.

The system (210) is engineered to accommodate vine plants within containers and indoor settings, providing a supportive structure that adapts to the spatial constraints and environmental conditions of varied gardening environments. The design allows for the cultivation of plants in containers, beneficial for urban gardeners or those with limited outdoor space. This feature ensures that plants can thrive in a controlled environment, where soil quality, watering, and nutrient delivery can be closely monitored and adjusted.

Furthermore, the system extends its functionality to indoor cultivation, addressing the needs of gardeners who wish to grow vine plants inside their homes or in controlled climate settings. By facilitating indoor cultivation, the system ensures that plants receive adequate support while allowing for the customization of light exposure, temperature, and humidity levels to optimize plant growth. The system is crafted to integrate with the D-Vine Flex, ensuring that it does not compromise the plant's natural growth patterns or the gardener's ability to perform routine care activities such as pruning or harvesting. Its adaptability and ease of installation make it a user-friendly solution for a wide range of plant support needs, while its durable construction ensures long-term use and the ability to support the weight of fruiting plants.

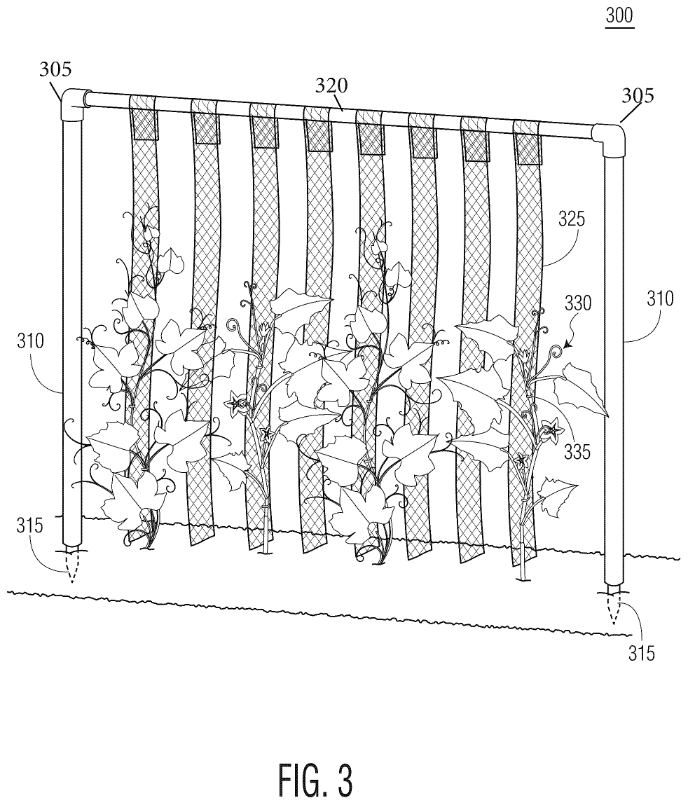

FIG. 3 illustrates an embodiment where the plant support system 300 consists of multiple interlocking components 305, 310, 315, 320, which can be assembled in various configurations to accommodate different plant growth requirements. The components 305, 310, 315, 320 provide structural integrity while allowing customization based on plant size and growth patterns. Component 305 are brackets allowing interconnection of support components 310 and 320. Component 320 is the vertical portion of the system. Component 310 is the horizontal portion of the system. In one embodiment, component 310 is oblique and bracket 305 is angled in order to facilitate interconnection of the system. The interlocking components 305 allow for easy expansion and reconfiguration, ensuring that the system can be adapted for different gardening environments, including small-scale home gardens and large agricultural setups. The different configurations of the system may include linear, grid, or pyramid-shaped arrangements to optimize space utilization and plant distribution. Furthermore, the support structure may be reinforced with additional crossbars or vertical extensions to enhance stability for climbing plants and heavy-yield crops. Component 325 is the netting. Any number of nettings 325 is used based on the length of component 320. Extension footings 315 are attached to support 320. In one embodiment, component 315 is implanted into the ground. In other embodiments, component 315 is implanted in the surface where system 300 is used. Items 330 and 335 show how the plants are attached to nettings 325.

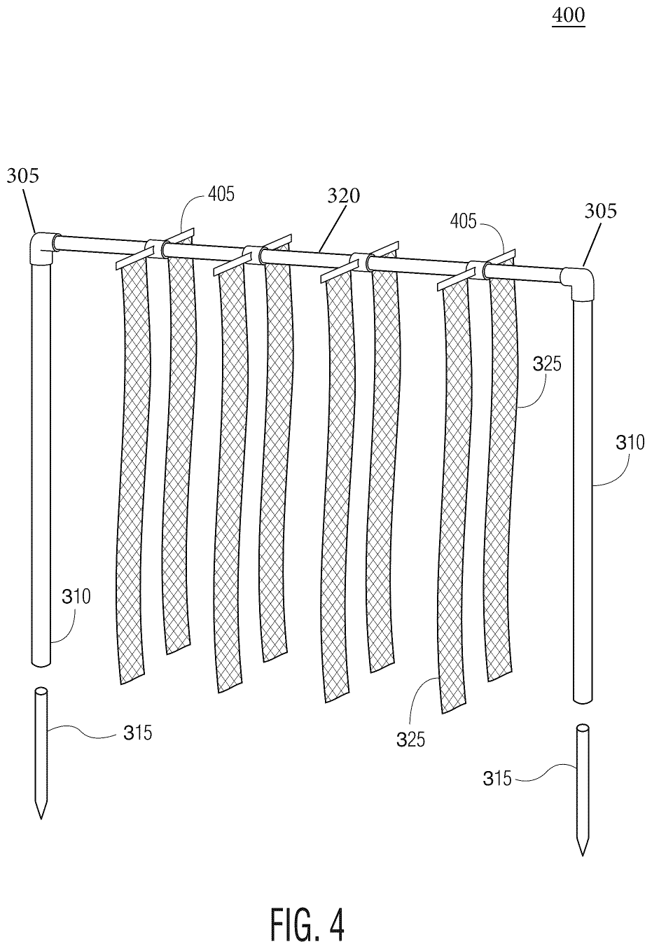

FIG. 4 depicts an alternative embodiment 400 where the plant support system is integrated with an adjustable support post assembly, 305, 410, 415. This embodiment allows the height and orientation of the system to be modified according to the specific needs of the plants being cultivated. In this embodiment, two (2) nettings 425 are attached to assembly 405. In other embodiments, more than two (2) nettings 425 can be attached to assembly 405, in which case assembly 405 is longer. The adjustable support post assembly 305 can be designed with telescoping sections, enabling users to extend or retract the height as required. Additionally, the assembly may include a pivoting mechanism to alter the angle of the support structure, accommodating climbing plants that require directional guidance. In one embodiment, implementations of the adjustable support post assembly include:
Telescoping Vertical Support: This configuration allows for incremental height adjustments to support the progressive growth of plants, such as tomatoes, beans, and peas.
Angled Support System: Designed for vine-based plants like grapes or ivy, this configuration facilitates plant attachment and natural growth along an inclined surface.
Rotating Support Mechanism: A pivoting arm system can be used for controlled positioning of plant support structures, ensuring optimal sun exposure and air circulation.
In other embodiments, other configurations are implemented by integrating these adjustable features. The plant support system enhances versatility, making it suitable for diverse plant species and growing conditions. This embodiment allows the height and orientation of the system to be modified according to the specific needs of the plants being cultivated.

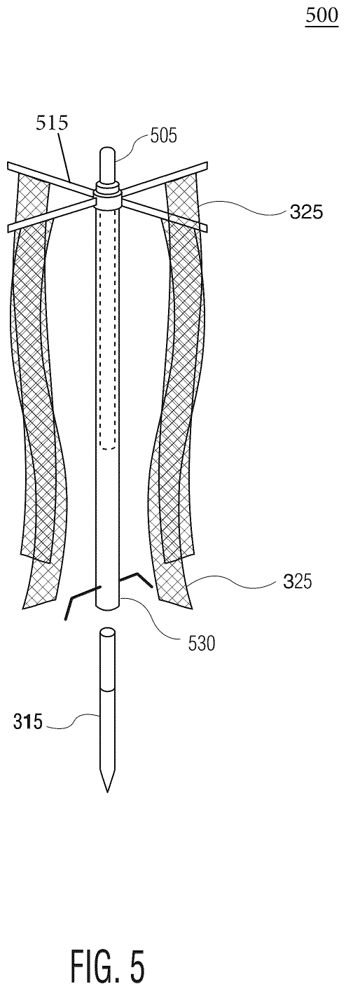

FIG. 5 presents another variation of the plant support system 500 featuring reinforced load-bearing sections 505, 515, 530, 535 making it ideal for supporting heavier plant varieties, such as climbing vines and fruit-bearing plants. These reinforced sections may include cross-braced metal frameworks 515, which accommodate nettings 510, reinforced polymer supports, or high-strength treated wooden beams that provide additional load-bearing capabilities. In one embodiment, section 505 is fixed. In other embodiment, section 505 is moveable along section 530. In one embodiment, Cross-braced Support Frames 515 is rotatable (360°) to be locked in any fixed position. In other embodiments, Cross-braced Support Frames 515 is rotatable (360°) to be locked in specific position, for example 45°, 90°, 180°. Other fixed positions can be configured. In other embodiments, Cross-braced Support Frames 515 position is fixed. Yet, in other embodiments, Cross-braced Support Frames 515 is vertically moveable along section 530. In one embodiment, different reinforcement configurations include:
Cross-braced Support Frames 515: This configuration distributes weight evenly across the structure, making it suitable for large, fruit-bearing plants such as tomatoes, cucumbers, and melons.
Dual-Column Reinforced Posts 530, 535: Utilizing two vertical support posts connected by horizontal stabilizers, this design prevents bending or collapse under increased weight loads.
Load-Adjustable Support Beams 530, 535: Designed with modular extension arms that can be adjusted based on plant weight distribution, enabling growers to increase structural strength as plants mature.

By incorporating these reinforced load-bearing sections, the plant support system ensures durability and stability, even under high stress from plant growth and environmental conditions such as wind or heavy rainfall.

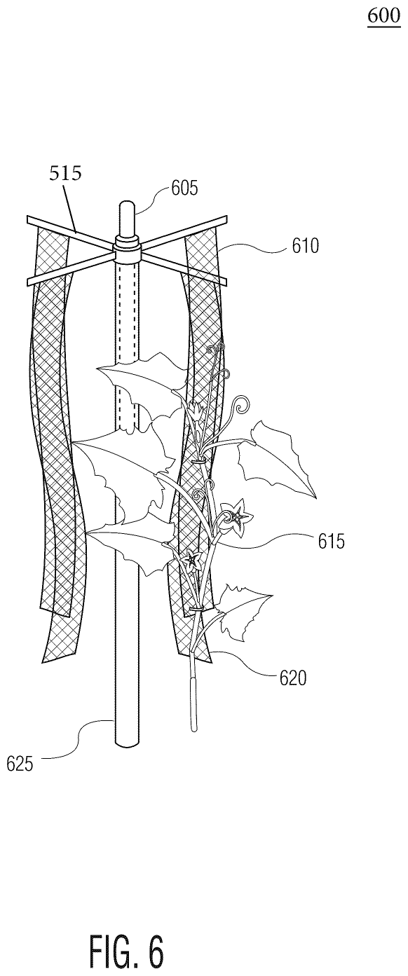

FIG. 6 showcases a lightweight, modular embodiment 600 designed for use in hydroponic and vertical farming environments. The configuration in this figure demonstrates how the plant support system can be effectively utilized in soil-less cultivation methods. This configuration is made up of Adjustable LED grow Light Attachment 605, Cross-braced Support Frames 515, Nets 610, 620 Stackable, Vertical Support Frame 625. In one embodiment, section 605 is fixed. In other embodiment, section 605 is moveable along section 625. In one embodiment, Cross-braced Support Frames 515 is rotatable (360°) to be locked in any fixed position. In other embodiments, Cross-braced Support Frames 515 is rotatable (360°) to be locked in specific position, for example 45°, 90°, 180°. Other fixed positions can be configured. In other embodiments, Cross-braced Support Frames 515 position is fixed. Yet, in other embodiments, Cross-braced Support Frames 515 is vertically moveable along section 625. Plant 615 is shown for illustrative purposes. Embodiments of different implementations of this configuration include:
Stackable Vertical Support Frames (625): These modular frames allow for multiple plant layers, maximizing the use of vertical space in hydroponic and aeroponic systems.
Integrated Drip Irrigation Channels (625): This configuration includes built-in irrigation systems that deliver nutrients and water directly to plant roots, optimizing growth efficiency.
Adjustable LED Grow Light Attachments (605): Designed for indoor vertical farms, this feature enables controlled lighting conditions that enhance photosynthesis and plant development.
Collapsible Frame Structure (625): A lightweight, foldable design allows for easy relocation and reconfiguration, making it suitable for both temporary and permanent plant installations.

By utilizing these configurations, the plant support system enhances space efficiency, ensures optimized nutrient distribution, and provides flexibility for a variety of plant cultivation methods, making it an ideal solution for modern agricultural practices. The configuration in this figure demonstrates how the plant support system can be effectively utilized in soil-less cultivation methods.

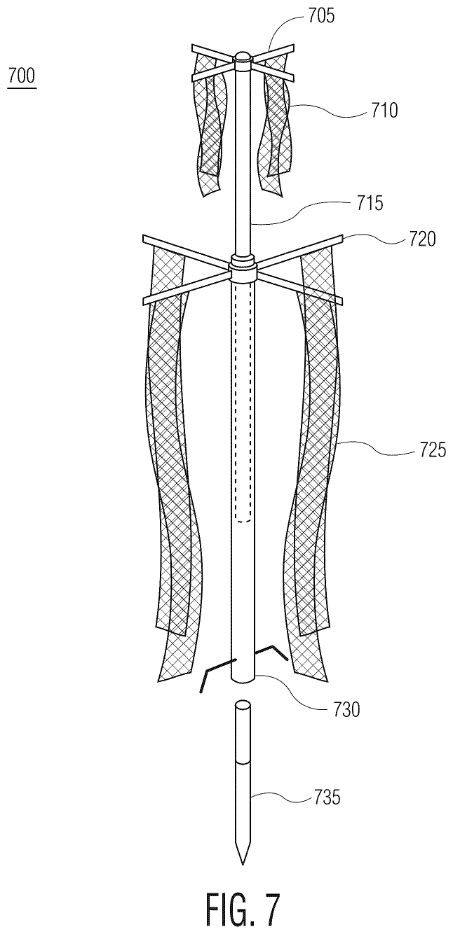

FIG. 7 illustrates a version of the plant support system 700 with enhanced anchoring mechanisms, 730, 735 ensuring stability in outdoor environments where weather conditions may impact plant support structures. The anchoring mechanisms are designed to prevent shifting, toppling, or detachment due to wind, heavy rainfall, or soil displacement. This configuration incorporates a mini or smaller Cross-braced Support Frames 705 anchoring nets 710, a smaller frame structure 715 attached to a larger frame 730. The larger frame structure 730 also houses larger Cross-braced Support Frames 720 anchoring nets 725. In one embodiment, section 715 is fixed. In other embodiment, section 715 is moveable along section 730. In one embodiment, Cross-braced Support Frames 705 and 720 are rotatable (360°) to be locked in any fixed position. In other embodiments, Cross-braced Support Frames 705 and 720 are rotatable (360°) to be locked in specific position, for example 45°, 90°, 180°. Other fixed positions can be configured. In other embodiments, Cross-braced Support Frames 705 and 720 position are fixed. Various enhanced anchoring configurations include:
Deep-Ground Spike Anchors (735): These anchors extend deep into the soil to provide extra stability against strong winds and shifting ground.
Weighted Base Supports (730): Incorporating heavy materials such as concrete or sand-filled bases, this system ensures that the support remains grounded even in adverse weather conditions.
Auger-Type Screw Anchors: These are spiraled metal or polymer screws that twist deep into the soil, providing a secure foundation that resists pulling forces.
Stake-and-Rope Tensioning System: This configuration uses adjustable ropes and stakes to create tension and keep the structure upright, particularly useful in sandy or loose soil environments.
Interlocking Ground Grids: A network of interlocked panels placed beneath the plant support structure to distribute weight evenly and prevent localized sinking or tilting.

By integrating these anchoring mechanisms, the plant support system enhances durability and resistance to environmental stressors, ensuring long-term stability and reliability for plant cultivation in various outdoor conditions.

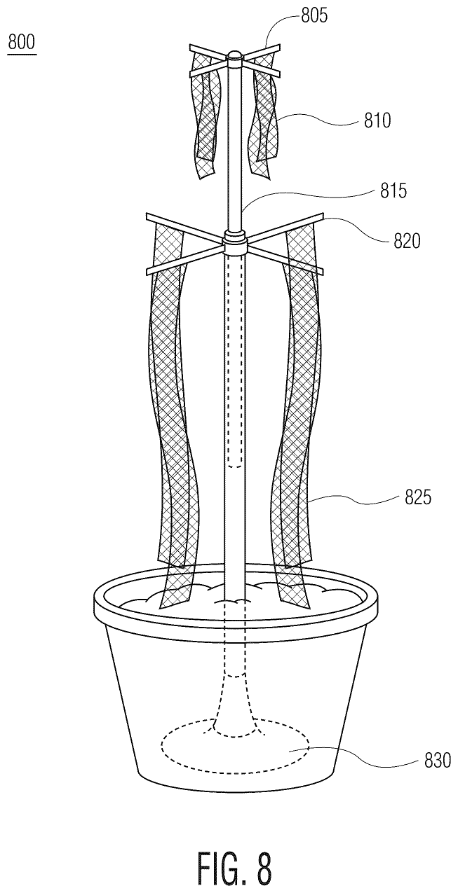

FIG. 8 provides a view of an embodiment 800 incorporating automated watering and nutrient delivery systems within the plant support framework 815, 830, optimizing plant health and growth efficiency. This embodiment integrates irrigation channels, nutrient distribution mechanisms, and moisture sensors to ensure that plants receive adequate hydration and essential nutrients. This configuration incorporates a mini or smaller Cross-braced Support Frames 805 anchoring nets 810, a smaller frame structure 815 attached to a larger frame 830. In one embodiment, smaller Cross-braced Support Frames 805 is rotatable to a fixed position. In other embodiments, smaller Cross-braced Support Frames 805 is fixed. Yet, in other embodiments, Cross-braced Support Frames 805 is moveable vertically along smaller frame structure 815. In one embodiment, smaller frame structure 815 is fixed. In other embodiment, section 815 is moveable along section 830. The larger frame structure 830 also houses larger Cross-braced Support Frames 820 anchoring nets 825. In one embodiment, Cross-braced Support Frames 805 and 820 are rotatable (360°) to be locked in any fixed position. In other embodiments, Cross-braced Support Frames 805 and 820 are rotatable (360°) to be locked in specific position, for example 45°, 90°, 180°. Other fixed positions can be configured. In other embodiments, Cross-braced Support Frames 805 and 820 position are fixed. In other embodiments, smaller Cross-braced Support Frames 805 are fixed. Yet, in other embodiments Cross-braced Support Frames 805 are moveable along smaller frame structure 815. In other embodiments, Cross-braced Support Frames 820 are moveable along larger frame structure 830. In other embodiments, Cross-braced Support Frames 820 are moveable along both smaller frame structure 815 and larger frame structure 830. Accordingly, embodiment 800 is very flexible facilitating a number of configurations within the limits of the mechanical structure as shown. Examples of different implementations of this embodiment include:
Drip Irrigation System: A network of tubes 815, 830 and emitters that deliver water directly to plant roots, minimizing water waste and ensuring consistent moisture levels.
Automated Misting System: Sprayers positioned along the support structure provide fine misting, ideal for delicate plants such as herbs and microgreens that require high humidity.
Fertilizer Injection System: A nutrient delivery mechanism that automatically mixes and distributes fertilizers through the irrigation lines, promoting balanced plant growth.
Soil Moisture and pH Sensors: Integrated sensors monitor soil conditions and adjust watering and nutrient delivery based on real-time plant needs, optimizing resource efficiency.
Hydroponic Integration: A configuration that supports hydroponic farming by circulating nutrient-rich water through the support system, eliminating the need for soil.
Rainwater Collection and Recycling: A built-in system that captures and filters rainwater for sustainable irrigation, reducing water consumption.

By implementing these automated watering and nutrient delivery systems, the plant support system enhances efficiency, reduces manual labor, and ensures optimal plant health in both controlled indoor environments and outdoor agricultural settings.

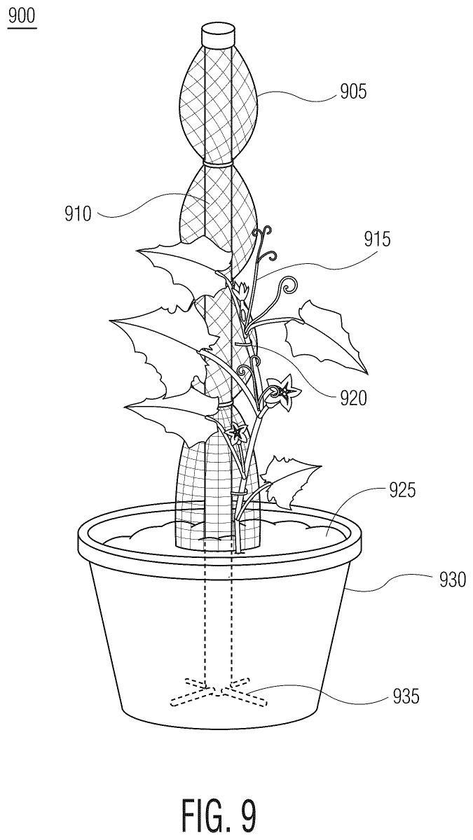

FIG. 9 details a collapsible and portable embodiment of the plant support system 900, making it ideal for temporary gardening setups and seasonal plant cultivation. This embodiment is designed for easy disassembly and reassembly, allowing users to transport and store the system when not in use. The collapsible framework consists of lightweight yet durable materials, such as aluminum alloys, reinforced polymers, or high-strength composite plastics, ensuring portability without compromising structural integrity. Plant 915, soil 925 and pot 930 are for illustrative purposes only. Examples of different implementations of this embodiment include:
Foldable Frame with Hinged Joints (935): This design allows the structure to be compacted into a smaller size for efficient storage and transport. The hinges lock securely when deployed, providing a stable support system for plants.
Telescoping Support Poles: Adjustable-length poles enable users to extend or collapse the structure as needed, making it adaptable to different plant growth stages and space requirements.
Modular Interlocking Panels (905, 910, 920): A system of detachable panels that can be quickly connected or separated, offering flexibility in configuration while ensuring secure structural support.
Quick-Release Fasteners: A tool-free assembly system utilizing snap-lock mechanisms for fast setup and takedown, making it user-friendly for home gardeners and commercial growers alike.
Lightweight Anchoring System: Instead of heavy bases, this version utilizes ground stakes or weighted bags that can be removed when relocating the system.

Alternative embodiments of the collapsible and portable plant support system include:
Compact Vertical Garden Structures: Designed for urban and small-space gardening, this configuration enables vertical plant stacking while maintaining portability.
Self-Expanding Frame with Spring Mechanisms: A frame that automatically expands when released from its compact form, providing rapid deployment for temporary installations.
Portable Greenhouse Integration: A hybrid embodiment that includes a retractable plastic cover or mesh netting to create a protective microenvironment for plants, shielding them from harsh weather conditions.

By incorporating these collapsible and portable features, the plant support system ensures maximum convenience, adaptability, and efficiency for users who require flexible gardening solutions for different seasons and environments. This embodiment allows users to disassemble and store the system when not in use, facilitating ease of transport and reinstallation.

Advantages of the Invention. The present invention offers several advantages over conventional plant support systems, including:
Enhanced adaptability to various gardening environments and plant types.
Improved airflow, sun exposure, and water drainage to promote plant health.
Modular and customizable structure for ease of use and maintenance.
Integration with automated watering and nutrient systems for optimized plant care.
Sustainable and durable construction materials to ensure longevity and environmental friendliness.

The various embodiments described above provide different configurations of the plant support system, enabling users to customize the structure based on specific plant growth requirements, environmental conditions, and gardening methods. The adaptability of the system ensures optimal support and plant health in a wide range of cultivation settings.

The present invention provides an effective and adaptable plant support solution that enhances plant growth while accommodating various gardening methods. The modular and flexible nature of the system allows users to cultivate plants efficiently in different environments, ensuring optimal plant health and productivity.

Finally, the language used in the specification has been principally selected for readability and instructional purposes, and it may not have been selected to delineate or circumscribe the inventive subject matter. It is therefore, intended that the scope of the invention be limited not by this detailed description, but rather by any claims that issue on an application based hereon. Although various embodiments, which incorporate the teachings of the present invention have been shown and described in detail herein, those skilled in the art can readily devise many other varied embodiments that still incorporate these teachings.

We/I claim:

1. A plant support system, comprising:
a plurality of interlocking components consisting of;
a plurality of vertical, horizontal support components;
a plurality of brackets allowing interconnection of said support components;
a plurality of extension footings attached to the support components; and
a plurality of nettings attached to the cross-bar portion of the support components;
wherein, the plant support system constitutes an apparatus allowing various structure arrangements demonstrating load-bearing capacity and configured to incorporate flexible netting for supporting or staking plants or vines, to thereby allow for more flexibility and natural growth of plants, better air flow, sun exposure, and water drainage and provide desired control of plants and vines in a plurality of environments.

2. The plant support system of claim 1, wherein the plant support system provides support to various types of plants including both indoors and outdoors plants.

3. The plant support system of claim 1, wherein the plant support system enables effective management of plants thereby enhancing environmental conditions for plant growth.

4. The plant support system of claim 1, wherein the plant support system is attached to a support post assembly thereby facilitating plant care activities.

5. The plant support system of claim 1, wherein the plant support system support diverse gardening methods thereby promoting plant reproduction.

6. The plant support system of claim 1, wherein the plant support system allows cultivation of plants with vines associated with containers.

7. The plant support system of claim 1, wherein the plant support system allows indoors cultivation of plants with vines.

8. A method for supporting plants, comprising:
providing a plant support system, which allows various structure arrangements demonstrating load-bearing capacity and configured to incorporate flexible netting for supporting or staking plants or vines; said plant supporting system further providing for:
a) using the plant support system to provide support to various types of plants;
b) facilitating natural growth of plants with the plant support system;
c) enabling effective management of plants with the plant support system;
d) enhancing environmental conditions for plant growth with the plant support system;
e) facilitating plant care activities with the plant support system;
f) supporting diverse gardening methods with the plant support system;
g) promoting plant reproduction with the plant support system; and
h) offering various plant support methods with the plant support system.

9. The method of claim 8, wherein the plant support system enables effective management of plants thereby enhancing environmental conditions for plant growth.

10. The method of claim 8, wherein the plant support system is attached to a support post assembly thereby facilitating plant care activities.

11. The method of claim 8, wherein the plant support system support diverse gardening methods thereby promoting plant reproduction.

12. The method of claim 8, wherein the plant support system permits better access for working around the plants.

13. The method of claim 8, wherein the plant support system allows cultivation of plants with vines associated with containers.

14. The method of claim 8, wherein the plant support system allows indoors cultivation of plants with vines.

15. A plant cultivation system comprising:
a hydroponic growth chamber configured to support plant roots in a nutrient-rich solution;
a reservoir for storing the nutrient-rich solution;
a pump operably connected to the reservoir and configured to circulate the nutrient-rich solution to the hydroponic growth chamber; and
a lighting system positioned to provide artificial light to plants in the hydroponic growth chamber.

16. The plant cultivation system of claim 16, wherein the hydroponic growth chamber comprises a plurality of plant support modules arranged to optimize nutrient absorption and root aeration.

17. A plant cultivation system comprising:
an aeroponic growth chamber configured to suspend plant roots in an air-filled environment;
a nutrient delivery system comprising at least one nozzle configured to mist nutrient-rich solution onto the suspended roots;
a reservoir for storing the nutrient-rich solution; and
a control system configured to regulate the timing and duration of nutrient misting.

18. The plant cultivation system of claim 17, wherein the aeroponic growth chamber includes a humidity sensor configured to adjust the misting intervals based on real-time moisture levels within the chamber.

19. A plant support system, comprising:
means for providing structural support to plants, the means including a modular and adaptable framework that allows for customizable configurations based on plant size and growth patterns;
means for adjusting the height and orientation of the support structure, the means including telescoping sections and pivoting mechanisms to support climbing plants;
means for reinforcing the structure to support heavier plant varieties, the means including cross-braced support frames, dual-column reinforced posts, and load-adjustable support beams;
means for securing the support system in various environments, the means including deep-ground spike anchors, weighted base supports, and auger-type screw anchors;
means for facilitating irrigation and nutrient distribution, the means including drip irrigation channels, misting sprayers, a fertilizer injection system, and embedded soil moisture and pH sensors;
means for enabling portability and collapsibility, the means including foldable frames with hinged joints, telescoping support poles, and quick-release fasteners; and
means for allowing flexible netting integration, the means including an adjustable netting attachment system to support different plant growth patterns while maintaining airflow and sun exposure.

20. A method for supporting plant growth using a plant support system, comprising:
providing means for supporting plants, wherein the support system includes an adaptable framework for various plant growth patterns;
using means for guiding plant growth, wherein plants are fastened to a flexible netting system that accommodates directional guidance and spacing;
applying means for optimizing environmental conditions, wherein airflow, sunlight exposure, and water drainage are enhanced through structural design;
utilizing means for securing the support structure, wherein anchoring mechanisms ensure stability in different gardening conditions;
integrating means for irrigation and nutrient delivery, wherein automated systems provide hydration and nutrition as needed; and
employing means for easy assembly and disassembly, wherein collapsible and portable features facilitate storage and transport.
